(19) United States
(12) Patent Application Publication
(10) Pub. No.: US 2011/0113352 A1
(43) Pub. Date: May 12, 2011

(54) PORTABLE ELECTRONIC DEVICE AND METHOD OF WEB PAGE RENDERING

(75) Inventors: Andrew Philip CUNDILL, Kanata (CA); Jeffrey Christopher ROGERS, Mississauga (CA)

(73) Assignee: RESEARCH IN MOTION LIMITED, Waterloo (CA)

(21) Appl. No.: 12/614,094

(22) Filed: Nov. 6, 2009

(51) Int. Cl. G06F 3/048

(52) U.S. Cl. 715/760; 715/810

(57) ABSTRACT

A portable electronic device-implemented method includes loading a first web page, rendering the first web page on a display of the portable electronic device, storing the first web page in memory at the portable electronic device, and rendering a first selectable representation of the first web page in a field on the display. The field includes at least one other selectable representation of another web page stored in memory.

### TECHNICAL FIELD

The present application relates to web page rendering on a display of a portable electronic device and storage at the portable electronic device.

### BACKGROUND DISCUSSION

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth capabilities.

Portable electronic devices such as PDAs or smart telephones are generally intended for handheld use and ease of portability. Smaller devices are generally desirable for portability. The displays of such handheld devices are small and therefore have limited space for user input and output. The information displayed, at one instance in time, on such displays is limited. With continued demand for decreased size of portable electronic devices, portable electronic device displays continue to decrease in size.

### BRIEF DESCRIPTION OF THE DRAWINGS

Embodiments of the present application will now be described, by way of example only, with reference to the attached Figures, wherein:

FIG. 1 is a block diagram of an example of an embodiment of a portable electronic device;

FIG. 2 is a block diagram of an example of a communication subsystem component of FIG. 1;

FIG. 3 is a block diagram of an example of an implementation of a node of a wireless network;

FIG. 4 is a block diagram illustrating components of an example of a configuration of a host system that the portable electronic device can communicate with;

FIG. 5 is a flowchart of an example of a method in accordance with the present disclosure; and

FIG. 6, FIG. 7 and FIG. 8 are examples of illustrations of screen shots of a portable electronic device in the method of FIG. 5.

### DETAILED DESCRIPTION

According to one aspect, a portable electronic device-implemented method includes loading a first web page, rendering the first web page on a display of the portable electronic device, storing the first web page in memory at the portable electronic device, and rendering a first selectable representation of the first web page in a field on the display. The field includes at least one other selectable representation of another web page stored in memory.

According to another aspect, a computer-readable medium has computer-readable code executable by at least one processor of a portable electronic device to perform the above method.

According to still another aspect, a portable electronic device includes a display, an input device, a memory, and a processor operably connected to the display, the input device and the memory to execute a program stored in the memory to cause the portable electronic device to load a first web page, render the first web page on the display, store the first web page in the memory, and render a first selectable representation of the first web page in a field on the display. The field includes at least one other selectable representation of another web page stored in memory.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The embodiments described herein generally relate to portable electronic devices. Examples of portable electronic devices include mobile or handheld wireless communication devices such as pagers, cellular phones, cellular smart-phones, wireless organizers, personal digital assistants, computers, laptops, handheld wireless communication devices, wirelessly enabled notebook computers and the like.

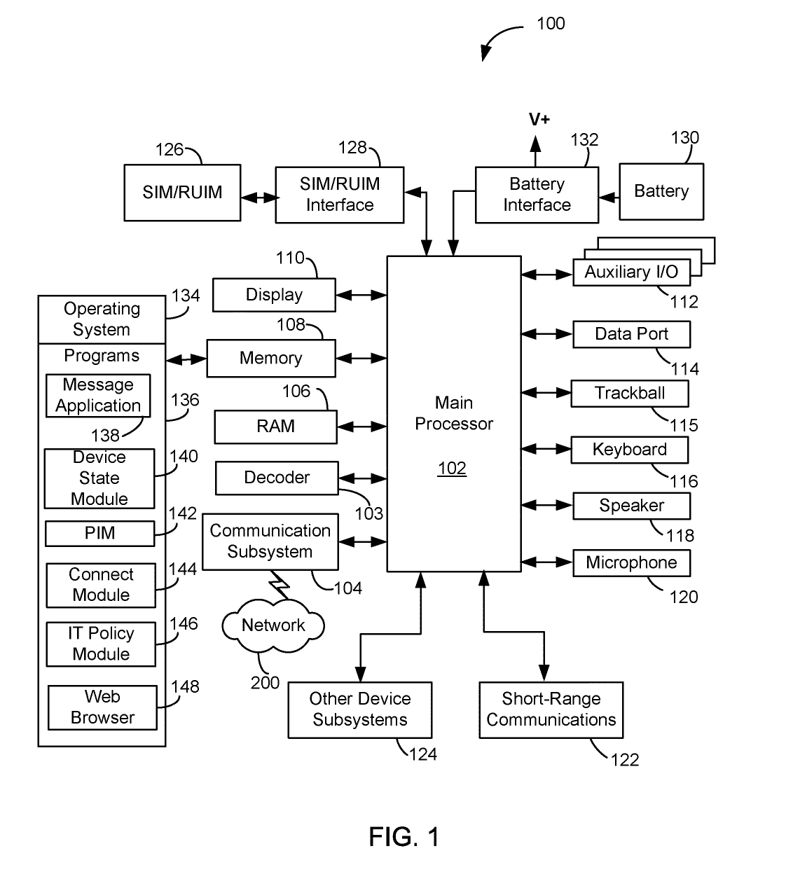

The portable electronic device may be a two-way communication device with advanced data communication capabilities including the capability to communicate with other portable electronic devices or computer systems through a network of transceiver stations. The portable electronic device may also have the capability to allow voice communication. Depending on the functionality provided by the portable electronic device, it may be referred to as a data messaging device, a two-way pager, a cellular telephone with data messaging capabilities, a wireless Internet appliance, or a data communication device (with or without telephony capabilities). To aid the reader in understanding the structure of the portable electronic device and how it communicates with other devices and host systems, reference will now be made to FIGS. 1 through 4.

Referring first to FIG. 1, shown therein is a block diagram of an example of an embodiment of a portable electronic device 100. The portable electronic device 100 includes a number of components such as a main processor 102 that controls the overall operation of the portable electronic device 100. Communication functions, including data and voice communications, are performed through a communication subsystem 104. Data received by the portable electronic device 100 can be decompressed and decrypted by a decoder 103, operating according to any suitable decompression techniques (e.g. YK decompression, and other known techniques) and encryption techniques (e.g. using an encryption technique such as Data Encryption Standard (DES), Triple DES, or Advanced Encryption Standard (AES)). The communication subsystem 104 receives messages from and sends messages to a wireless network 200. In this example of an embodiment of the portable electronic device 100, the communication subsystem 104 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 200 associated with portable electronic device 100 is a GSM/GPRS wireless network in one example of an implementation, other wireless networks may also be associated with the portable electronic device 100 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and third-generation (3G) networks such as EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems. The main processor 102 also interacts with additional subsystems such as a Random Access Memory (RAM) 106, memory 108, a display 110, an auxiliary input/output (I/O) subsystem 112, a data port 114, a trackball 115, a keyboard 116, a speaker 118, a microphone 120, short-range communications 122 and other device subsystems 124.

Some of the subsystems of the portable electronic device 100 perform communication-related functions, whereas other subsystems may provide “resident” or on-device functions. By way of example, the display 110, the trackball 115 and the keyboard 116 may be used for both communication-related functions, such as entering a text message for transmission over the network 200, and device-resident functions such as a calculator or task list.

The portable electronic device 100 can send and receive communication signals over the wireless network 200 after network registration or activation procedures have been completed. Network access is associated with a subscriber or user of the portable electronic device 100. To identify a subscriber, a SIM/RUIM card 126 (i.e. Subscriber Identity Module or a Removable User Identity Module) is inserted into a SIM/RUIM interface 128 in order to communicate with a network. The SIM/RUIM card 126 is a type of a conventional “smart card” that can be used to identify a subscriber of the portable electronic device 100 and to personalize the portable electronic device 100, among other things. In the present embodiment, the portable electronic device 100 is not fully operational for communication with the wireless network 200 without the SIM/RUIM card 126. By inserting the SIM/RUIM card 126 into the SIM/RUIM interface 128, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM/RUIM card 126 includes a processor and memory for storing information. Once the SIM/RUIM card 126 is inserted into the SIM/RUIM interface 128, it is coupled to the main processor 102. In order to identify the subscriber, the SIM/RUIM card 126 can include some user parameters such as an International Mobile Subscriber Identity (IMSI). An advantage of using the SIM/RUIM card 126 is that a subscriber is not necessarily bound by any single physical portable electronic device. The SIM/RUIM card 126 may store additional subscriber information for a portable electronic device as well, including datebook (or calendar) information and recent call information. Alternatively, user identification information can also be programmed into memory 108.

The portable electronic device 100 is a battery-powered device and includes a battery interface 132 for receiving one or more rechargeable batteries 130. In at least some embodiments, the battery 130 can be a smart battery with an embedded microprocessor. The battery interface 132 is coupled to a regulator (not shown), which assists the battery 130 in providing power V+ to the portable electronic device 100. Although current technology makes use of a battery, future technologies such as micro fuel cells may provide the power to the portable electronic device 100.

The portable electronic device 100 also includes an operating system 134 and software components 136 which are described in more detail below. The operating system 134 and the software components 136 that are executed by the main processor 102 are typically stored in a persistent, updatable store such as the memory 108. Those skilled in the art will appreciate that portions of the operating system 134 and the software components 136, such as specific device applications 138, 140, 142, 144, 146, 148 or parts thereof, may be temporarily loaded into a volatile store such as the RAM 106. Other software components can also be included, as is well known to those skilled in the art.

The subset of software components 136 that control basic device operations, including data and voice communication applications are installed on the portable electronic device 100 during its manufacture. Other software applications include a message application 138 that can be any suitable software program that allows a user of the portable electronic device 100 to send and receive electronic messages. Various alternatives exist for the message application 138 as is well known to those skilled in the art. Messages that have been sent or received by the user are typically stored in the memory 108 of the portable electronic device 100 or some other suitable storage element in the portable electronic device 100. In at least some embodiments, some of the sent and received messages may be stored remotely from the device 100 such as in a data store of an associated host system that the portable electronic device 100 communicates with.

The software components 136 can further include a device state module 140, a Personal Information Manager (PIM) 142, and other suitable modules (not shown). The device state module 140 provides persistence, i.e. the device state module 140 ensures that important device data is stored in persistent memory, such as the memory 108, so that the data is not lost when the portable electronic device 100 is turned off or loses power.

The PIM 142 includes functionality for organizing and managing data items of interest to the user, such as, but not limited to, e-mail, contacts, calendar events, voice mails, appointments, and task items. PIM applications include, for example, calendar, address book, tasks and memo applications. The PIM 142 has the ability to send and receive data items via the wireless network 200. PIM data items may be seamlessly integrated, synchronized, and updated via the wireless network 200 with the portable electronic device subscriber's corresponding data items stored and/or associated with a host computer system. This functionality creates a mirrored host computer on the portable electronic device 100 with respect to such items. This can be particularly advantageous when the host computer system is the portable electronic device subscriber's office computer system.

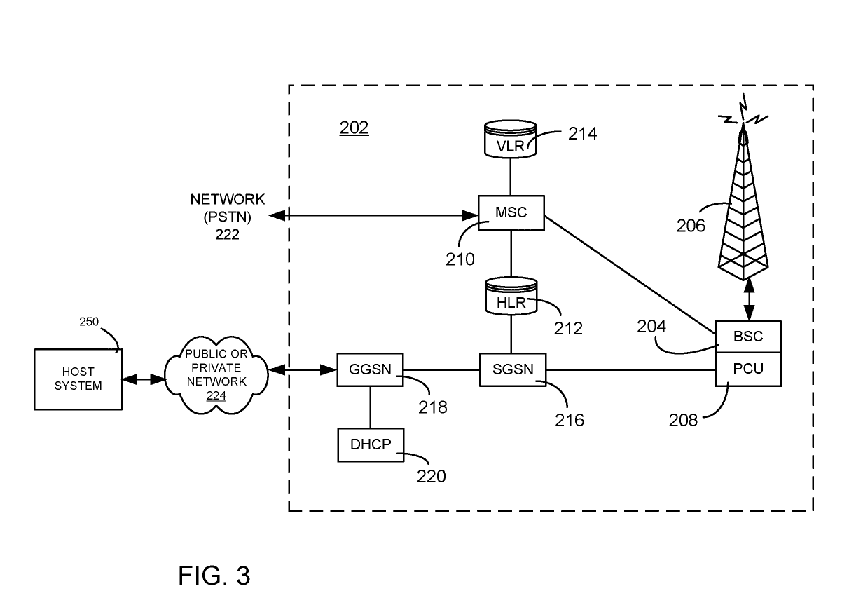

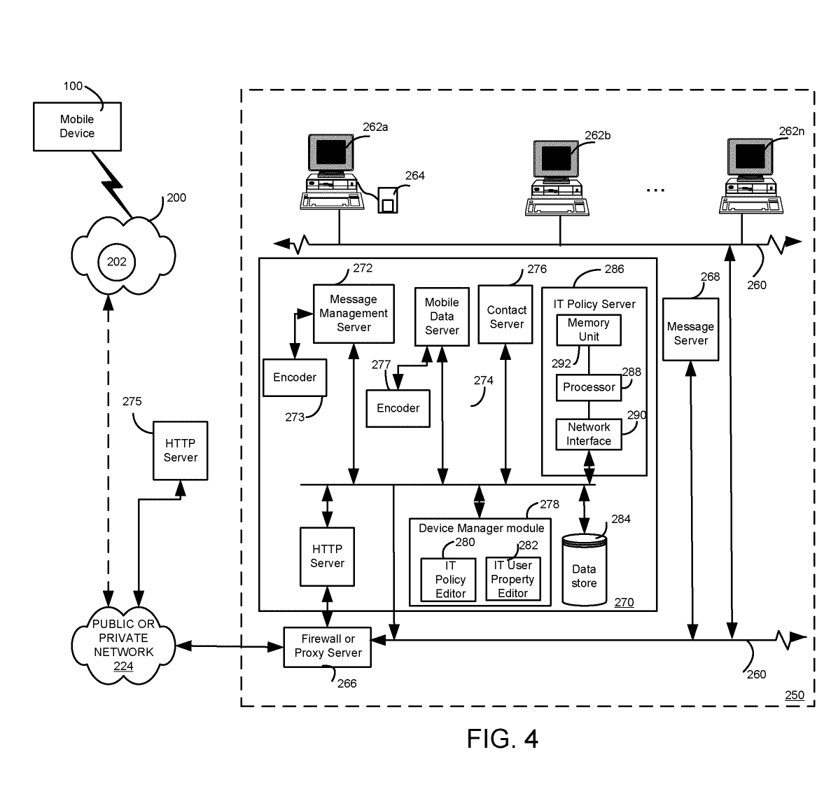

The software components 62 also includes a connect module 144, and an information technology (IT) policy module 146. The connect module 144 implements the communication protocols that are required for the portable electronic device 100 to communicate with the wireless infrastructure and any host system, such as an enterprise system, that the portable electronic device 100 is authorized to interface with. Examples of a wireless infrastructure and an enterprise system are given in FIGS. 3 and 4, which are described in more detail below.

The connect module 144 includes a set of APIs that can be integrated with the portable electronic device 100 to allow the portable electronic device 100 to use any number of services associated with the enterprise system. The connect module 144 allows the portable electronic device 100 to establish an end-to-end secure, authenticated communication pipe with the host system. A subset of applications for which access is provided by the connect module 144 can be used to pass IT policy commands from the host system to the portable electronic device 100. This can be done in a wireless or wired manner. These instructions can then be passed to the IT policy module 146 to modify the configuration of the device 100. Alternatively, in some cases, the IT policy update can also be done over a wired connection.

Other types of software applications can also be provided on the portable electronic device 100, including the Web browser 148 for enabling a user to display and interact with text, images, videos, music and other information from a webpage at a website on the world wide web or on a local network.

Still other types of software applications can be installed on the portable electronic device 100. Such software applications can be third party applications, which are added after the manufacture of the portable electronic device 100. Examples of third party applications include games, calculators, utilities, etc.

The additional applications can be loaded onto the portable electronic device 100 through at least one of the wireless network 200, the auxiliary I/O subsystem 112, the data port 114, the short-range communications subsystem 122, or any other suitable device subsystem 124. This flexibility in application installation increases the functionality of the portable electronic device 100 and may provide enhanced on-device functions, communication-related functions, or both. For example, secure communication applications may enable electronic commerce functions and other such financial transactions to be performed using the portable electronic device 100.

The data port 114 enables a subscriber to set preferences through an external device or software application and extends the capabilities of the portable electronic device 100 by providing for information or software downloads to the portable electronic device 100 other than through a wireless communication network. The alternate download path may, for example, be used to load an encryption key onto the portable electronic device 100 through a direct and thus reliable and trusted connection to provide secure device communication.

The data port 114 can be any suitable port that enables data communication between the portable electronic device 100 and another computing device. The data port 114 can be a serial or a parallel port. In some instances, the data port 114 can be a USB port that includes data lines for data transfer and a supply line that can provide a charging current to charge the battery 130 of the portable electronic device 100.

The short-range communications subsystem 122 provides for communication between the portable electronic device 100 and different systems or devices, without the use of the wireless network 200. For example, the subsystem 122 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, webpage download, or any other information is processed by the communication subsystem 104 and input to the main processor 102 where the received signal is processed for output to the display 110 or alternatively to the auxiliary I/O subsystem 112. A subscriber may also compose data items, such as e-mail messages, for example, using the keyboard 116 in conjunction with the display 110 and possibly the auxiliary I/O subsystem 112. The auxiliary subsystem 112 may include devices such as: a touch screen, mouse, track ball, infrared fingerprint detector, or a roller wheel with dynamic button pressing capability. The keyboard 116 is preferably an alphanumeric keyboard and/or telephone-type keypad. However, other types of keyboards may also be used. A composed item may be transmitted over the wireless network 200 through the communication subsystem 104.

For voice communications, the overall operation of the portable electronic device 100 is substantially similar, except that the received signals are output to the speaker 118, and signals for transmission are generated by the microphone 120. Alternative voice or audio I/O subsystems, such as a voice message recording subsystem, can also be implemented on the portable electronic device 100. Although voice or audio signal output is accomplished primarily through the speaker 118, the display 110 can also be used to provide additional information such as the identity of a calling party, duration of a voice call, or other voice call related information.

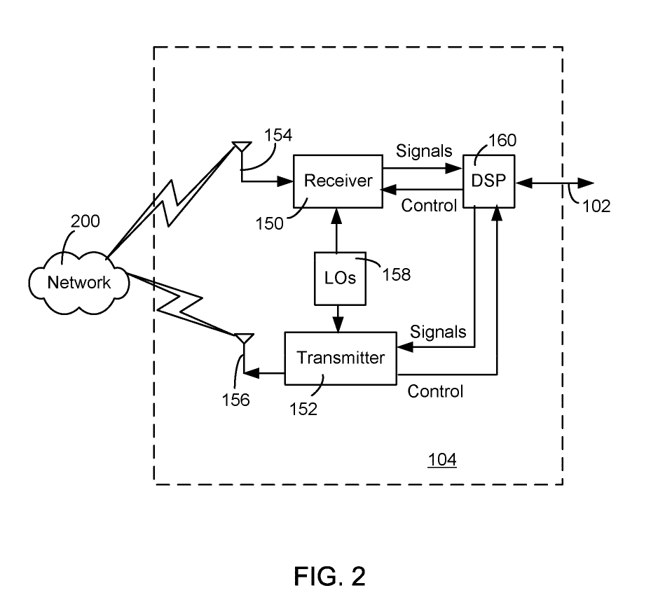

Referring now to FIG. 2, a block diagram of an example of the communication subsystem component 104 is shown. The communication subsystem 104 includes a receiver 150, a transmitter 152, as well as associated components such as one or more embedded or internal antenna elements 154 and 156, Local Oscillators (LOs) 158, and a processing module such as a Digital Signal Processor (DSP) 160. The particular design of the communication subsystem 104 is dependent upon the communication network 200 with which the portable electronic device 100 is intended to operate. Thus, it should be understood that the design illustrated in FIG. 2 serves only as one example.

Signals received by the antenna 154 through the wireless network 200 are input to the receiver 150, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 160. In a similar manner, signals to be transmitted are processed, including modulation and encoding, by the DSP 160. These DSP-processed signals are input to the transmitter 152 for digital-to-analog (D/A) conversion, frequency up conversion, filtering, amplification and transmission over the wireless network 200 via the antenna 156. The DSP 160 not only processes communication signals, but also provides for receiver and transmitter control. For example, the gains applied to communication signals in the receiver 150 and the transmitter 152 may be adaptively controlled through automatic gain control algorithms implemented in the DSP 160.

The wireless link between the portable electronic device 100 and the wireless network 200 can contain one or more different channels, typically different RF channels, and associated protocols used between the portable electronic device 100 and the wireless network 200. An RF channel is a limited resource that should be conserved, typically due to limits in overall bandwidth and limited battery power of the portable electronic device 100.

When the portable electronic device 100 is fully operational, the transmitter 152 is typically keyed or turned on only when it is transmitting to the wireless network 200 and is otherwise turned off to conserve resources. Similarly, the receiver 150 is periodically turned off to conserve power until it is needed to receive signals or information (if at all) during designated time periods.

Referring now to FIG. 3, a block diagram of an example of an implementation of a node 202 of the wireless network 200 is shown. In practice, the wireless network 200 comprises one or more nodes 202. In conjunction with the connect module 144, the portable electronic device 100 can communicate with the node 202 within the wireless network 200. In the example of FIG. 3, the node 202 is configured in accordance with General Packet Radio Service (GPRS) and Global Systems for Mobile (GSM) technologies. The node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through the network 200.

In a GSM network, the MSC 210 is coupled to the BSC 204 and to a landline network, such as a Public Switched Telephone Network (PSTN) 222 to satisfy circuit switched requirements. The connection through the PCU 208, the SGSN 216 and the GGSN 218 to a public or private network (Internet) 224 (also referred to herein generally as a shared network infrastructure) represents the data path for GPRS capable portable electronic devices. In a GSM network extended with GPRS capabilities, the BSC 204 also contains the Packet Control Unit (PCU) 208 that connects to the SGSN 216 to control segmentation, radio channel allocation and to satisfy packet switched requirements. To track the location of the portable electronic device 100 and availability for both circuit switched and packet switched management, the HLR 212 is shared between the MSC 210 and the SGSN 216. Access to the VLR 214 is controlled by the MSC 210.

The station 206 is a fixed transceiver station and together with the BSC 204 form fixed transceiver equipment. The fixed transceiver equipment provides wireless network coverage for a particular coverage area commonly referred to as a “cell”. The fixed transceiver equipment transmits communication signals to and receives communication signals from portable electronic devices within its cell via the station 206. The fixed transceiver equipment normally performs such functions as modulation and possibly encoding and/or encryption of signals to be transmitted to the portable electronic device 100 in accordance with particular, usually predetermined, communication protocols and parameters, under control of its controller. The fixed transceiver equipment similarly demodulates and possibly decodes and decrypts, if necessary, any communication signals received from the portable electronic device 100 within its cell. Communication protocols and parameters may vary between different nodes. For example, one node may employ a different modulation scheme and operate at different frequencies than other nodes.

For all portable electronic devices 100 registered with a specific network, permanent configuration data such as a user profile is stored in the HLR 212. The HLR 212 also contains location information for each registered portable electronic device and can be queried to determine the current location of a portable electronic device. The MSC 210 is responsible for a group of location areas and stores the data of the portable electronic devices currently in its area of responsibility in the VLR 214. Further, the VLR 214 also contains information on portable electronic devices that are visiting other networks. The information in the VLR 214 includes part of the permanent portable electronic device data transmitted from the HLR 212 to the VLR 214 for faster access. By moving additional information from a remote HLR 212 node to the VLR 214, the amount of traffic between these nodes can be reduced so that voice and data services can be provided with faster response times and at the same time requiring less use of computing resources.

The SGSN 216 and the GGSN 218 are elements added for GPRS support; namely packet switched data support, within GSM. The SGSN 216 and the MSC 210 have similar responsibilities within the wireless network 200 by keeping track of the location of each portable electronic device 100. The SGSN 216 also performs security functions and access control for data traffic on the wireless network 200. The GGSN 218 provides internetworking connections with external packet switched networks and connects to one or more SGSN's 216 via an Internet Protocol (IP) backbone network operated within the network 200. During normal operations, a given portable electronic device 100 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 220 connected to the GGSN 218. There are many mechanisms for dynamic IP assignment, including using a combination of a Remote Authentication Dial-In User Service (RADIUS) server and a DHCP server. Once the GPRS Attach is complete, a logical connection is established from a portable electronic device 100, through the PCU 208, and the SGSN 216 to an Access Point Node (APN) within the GGSN 218. The APN represents a logical end of an IP tunnel that can either access direct Internet compatible services or private network connections. The APN also represents a security mechanism for the network 200, insofar as each portable electronic device 100 must be assigned to one or more APNs and portable electronic devices 100 cannot exchange data without first performing a GPRS Attach to an APN that it has been authorized to use. The APN may be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, the network 200 will run an idle timer for each PDP Context to determine if there is a lack of activity. When a portable electronic device 100 is not using its PDP Context, the PDP Context can be de-allocated and the IP address returned to the IP address pool managed by the DHCP server 220.

Referring now to FIG. 4, shown therein is a block diagram illustrating components of an example of a configuration of a host system 250 that the portable electronic device 100 can communicate with in conjunction with the connect module 144. The host system 250 will typically be a corporate enterprise or other local area network (LAN), but may also be a home office computer or some other private system, for example, in variant implementations. In this example shown in FIG. 4, the host system 250 is depicted as a LAN of an organization to which a user of the portable electronic device 100 belongs. Typically, a plurality of portable electronic devices can communicate wirelessly with the host system 250 through one or more nodes 202 of the wireless network 200.

The host system 250 comprises a number of network components connected to each other by a network 260. For instance, a user's desktop computer 262a with an accompanying cradle 264 for the user's portable electronic device 100 is situated on a LAN connection. The cradle 264 for the portable electronic device 100 can be coupled to the computer 262a by a serial or a Universal Serial Bus (USB) connection, for example. Other user computers 262b-262n are also situated on the network 260, and each may or may not be equipped with an accompanying cradle 264. The cradle 264 facilitates the loading of information (e.g. PIM data, private symmetric encryption keys to facilitate secure communications) from the user computer 262a to the portable electronic device 100, and may be particularly useful for bulk information updates often performed in initializing the portable electronic device 100 for use. The information downloaded to the portable electronic device 100 may include certificates used in the exchange of messages.

It will be understood by persons skilled in the art that the user computers 262a-262n will typically also be connected to other peripheral devices, such as printers, etc. which are not explicitly shown in FIG. 4. Furthermore, only a subset of network components of the host system 250 are shown in FIG. 4 for ease of exposition, and it will be understood by persons skilled in the art that the host system 250 will comprise additional components that are not explicitly shown in FIG. 4 for this example configuration. More generally, the host system 250 may represent a smaller part of a larger network (not shown) of the organization, and may comprise different components and/or be arranged in different topologies than that shown in the example of FIG. 4.

To facilitate the operation of the portable electronic device 100 and the wireless communication of messages and message-related data between the portable electronic device 100 and components of the host system 250, a number of wireless communication support components 270 can be provided. In some implementations, the wireless communication support components 270 can include a management server 272, a mobile data server (MDS) 274, a web server, such as Hypertext Transfer Protocol (HTTP) server 275, a contact server 276, and a device manager module 278. HTTP servers can also be located outside the enterprise system, as indicated by the HTTP server 275 attached to the network 224. The device manager module 278 includes an IT Policy editor 280 and an IT user property editor 282, as well as other software components for allowing an IT administrator to configure the portable electronic devices 100. In an alternative embodiment, there may be one editor that provides the functionality of both the IT policy editor 280 and the IT user property editor 282. The support components 270 also include a data store 284, and an IT policy server 286. The IT policy server 286 includes a processor 288, a network interface 290 and a memory unit 292. The processor 288 controls the operation of the IT policy server 286 and executes functions related to the standardized IT policy as described below. The network interface 290 allows the IT policy server 286 to communicate with the various components of the host system 250 and the portable electronic devices 100. The memory unit 292 can store functions used in implementing the IT policy as well as related data. Those skilled in the art know how to implement these various components. Other components may also be included as is well known to those skilled in the art. Further, in some implementations, the data store 284 can be part of any one of the servers.

In this example, the portable electronic device 100 communicates with the host system 250 through node 202 of the wireless network 200 and a shared network infrastructure 224 such as a service provider network or the public Internet. Access to the host system 250 may be provided through one or more routers (not shown), and computing devices of the host system 250 may operate from behind a firewall or proxy server 266. The proxy server 266 provides a secure node and a wireless internet gateway for the host system 250. The proxy server 266 intelligently routes data to the correct destination server within the host system 250.

In some implementations, the host system 250 can include a wireless VPN router (not shown) to facilitate data exchange between the host system 250 and the portable electronic device 100. The wireless VPN router allows a VPN connection to be established directly through a specific wireless network to the portable electronic device 100. The wireless VPN router can be used with the Internet Protocol (IP) Version 6 (IPV6) and IP-based wireless networks. This protocol can provide enough IP addresses so that each portable electronic device has a dedicated IP address, making it possible to push information to a portable electronic device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the portable electronic device 100 in this alternative implementation.

Messages intended for a user of the portable electronic device 100 are initially received by a message server 268 of the host system 250. Such messages may originate from any number of sources. For instance, a message may have been sent by a sender from the computer 262b within the host system 250, from a different portable electronic device (not shown) connected to the wireless network 200 or a different wireless network, or from a different computing device, or other device capable of sending messages, via the shared network infrastructure 224, possibly through an application service provider (ASP) or Internet service provider (ISP), for example.

The message server 268 typically acts as the primary interface for the exchange of messages, particularly e-mail messages, within the organization and over the shared network infrastructure 224. Each user in the organization that has been set up to send and receive messages is typically associated with a user account managed by the message server 268. Some examples of implementations of the message server 268 include a Microsoft Exchange™ server, a Lotus Domino™ server, a Novell Groupwise™ server, or another suitable mail server installed in a corporate environment. In some implementations, the host system 250 may comprise multiple message servers 268. The message server provides additional functions including PIM functions such as calendaring, contacts and tasks and supports data storage.

When messages are received by the message server 268, they are typically stored in a data store associated with the message server 268. In at least some embodiments, the data store may be a separate hardware unit, such as data store 284, that the message server 268 communicates with. Messages can be subsequently retrieved and delivered to users by accessing the message server 268. For instance, an e-mail client application operating on a user's computer 262a may request the e-mail messages associated with that user's account stored on the data store associated with the message server 268. These messages are then retrieved from the data store and stored locally on the computer 262a. The data store associated with the message server 268 can store copies of each message that is locally stored on the portable electronic device 100. Alternatively, the data store associated with the message server 268 can store all of the messages for the user of the portable electronic device 100 and only a smaller number of messages can be stored on the portable electronic device 100 to conserve memory. For instance, the most recent messages (i.e. those received in the past two to three months for example) can be stored on the portable electronic device 100.

When operating the portable electronic device 100, the user may wish to have e-mail messages retrieved for delivery to the portable electronic device 100. The message application 138 operating on the portable electronic device 100 may also request messages associated with the user's account from the message server 268. The message application 138 may be configured (either by the user or by an administrator, possibly in accordance with an organization's IT policy) to make this request at the direction of the user, at some pre-defined time interval, or upon the occurrence of some pre-defined event. In some implementations, the portable electronic device 100 is assigned its own e-mail address, and messages addressed specifically to the portable electronic device 100 are automatically redirected to the portable electronic device 100 as they are received by the message server 268.

The management server 272 can be used to specifically provide support for the management of, for example, messages, such as e-mail messages, that are to be handled by portable electronic devices. Generally, while messages are still stored on the message server 268, the management server 272 can be used to control when, if, and how messages are sent to the portable electronic device 100. The management server 272 also facilitates the handling of messages composed on the portable electronic device 100, which are sent to the message server 268 for subsequent delivery.

For example, the management server 272 may monitor the user's “mailbox” (e.g. the message store associated with the user's account on the message server 268) for new e-mail messages, and apply user-definable filters to new messages to determine if and how the messages are relayed to the user's portable electronic device 100. The management server 272 may also, through an encoder 273, compress messages, using any suitable compression technology (e.g. YK compression, and other known techniques) and encrypt messages (e.g. using an encryption technique such as Data Encryption Standard (DES), Triple DES, or Advanced Encryption Standard (AES)), and push them to the portable electronic device 100 via the shared network infrastructure 224 and the wireless network 200. The management server 272 may also receive messages composed on the portable electronic device 100 (e.g. encrypted using Triple DES), decrypt and decompress the composed messages, re-format the composed messages if desired so that they will appear to have originated from the user's computer 262a, and re-route the composed messages to the message server 268 for delivery.

Certain properties or restrictions associated with messages that are to be sent from and/or received by the portable electronic device 100 can be defined (e.g. by an administrator in accordance with IT policy) and enforced by the management server 272. These may include whether the portable electronic device 100 may receive encrypted and/or signed messages, minimum encryption key sizes, whether outgoing messages must be encrypted and/or signed, and whether copies of all secure messages sent from the portable electronic device 100 are to be sent to a pre-defined copy address, for example.

The management server 272 may also be adapted to provide other control functions, such as only pushing certain message information or pre-defined portions (e.g. “blocks”) of a message stored on the message server 268 to the portable electronic device 100. For example, in some cases, when a message is initially retrieved by the portable electronic device 100 from the message server 268, the management server 272 may push only the first part of a message to the portable electronic device 100, with the part being of a pre-defined size (e.g. 2 KB). The user can then request that more of the message be delivered in similar-sized blocks by the management server 272 to the portable electronic device 100, possibly up to a maximum pre-defined message size. Accordingly, the management server 272 facilitates better control over the type of data and the amount of data that is communicated to the portable electronic device 100, and can help to minimize potential waste of bandwidth or other resources.

The MDS 274 encompasses any other server that stores information that is relevant to the corporation. The mobile data server 274 may include, but is not limited to, databases, online data document repositories, customer relationship management (CRM) systems, or enterprise resource planning (ERP) applications. The MDS 274 can also connect to the Internet or other public network, through HTTP server 275 or other suitable web server such as an File Transfer Protocol (FTP) server, to retrieve HTTP webpages and other data. Requests for webpages from the portable electronic device 100 are typically routed through MDS 274 and then to HTTP server 275, through suitable firewalls and other protective mechanisms. The web server then retrieves the webpage over the Internet, and returns it to MDS 274. As described above in relation to management server 272, MDS 274 is typically provided, or associated, with an encoder 277 that permits retrieved data, such as retrieved webpages, to be compressed, using any suitable compression technology (e.g. YK compression, and other known techniques), and encrypted (e.g. using an encryption technique such as DES, Triple DES, or AES), and then pushed to the portable electronic device 100 via the shared network infrastructure 224 and the wireless network 200.

The contact server 276 can provide information for a list of contacts for the user in a similar fashion as the address book on the portable electronic device 100. Accordingly, for a given contact, the contact server 276 can include the name, phone number, work address and e-mail address of the contact, among other information. The contact server 276 can also provide a global address list that contains the contact information for all of the contacts associated with the host system 250.

It will be understood by persons skilled in the art that the management server 272, the MDS 274, the HTTP server 275, the contact server 276, the device manager module 278, the data store 284 and the IT policy server 286 do not need to be implemented on separate physical servers within the host system 250. For example, some or all of the functions associated with the management server 272 may be integrated with the message server 268, or some other server in the host system 250. Alternatively, the host system 250 may comprise multiple management servers 272, particularly in variant implementations where a large number of portable electronic devices need to be supported.

The device manager module 278 provides an IT administrator with a graphical user interface with which the IT administrator interacts to configure various settings for the portable electronic devices 100. As mentioned, the IT administrator can use IT policy rules to define behaviors of certain applications on the portable electronic device 100 that are permitted such as phone, web browser or Instant Messenger use. The IT policy rules can also be used to set specific values for configuration settings that an organization requires on the portable electronic devices 100 such as auto signature text, WLAN/VoIP/VPN configuration, security requirements (e.g. encryption algorithms, password rules, etc.), specifying themes or applications that are allowed to run on the portable electronic device 100, and the like.

As indicated above, the portable electronic device 100 includes the Personal Information Manager (PIM) 142 that includes functionality for organizing and managing data items of interest to the user, such as, but not limited to, e-mail, contacts, calendar events, voice mails, appointments, and task items. PIM applications include, for example, calendar, address book, tasks and memo applications.

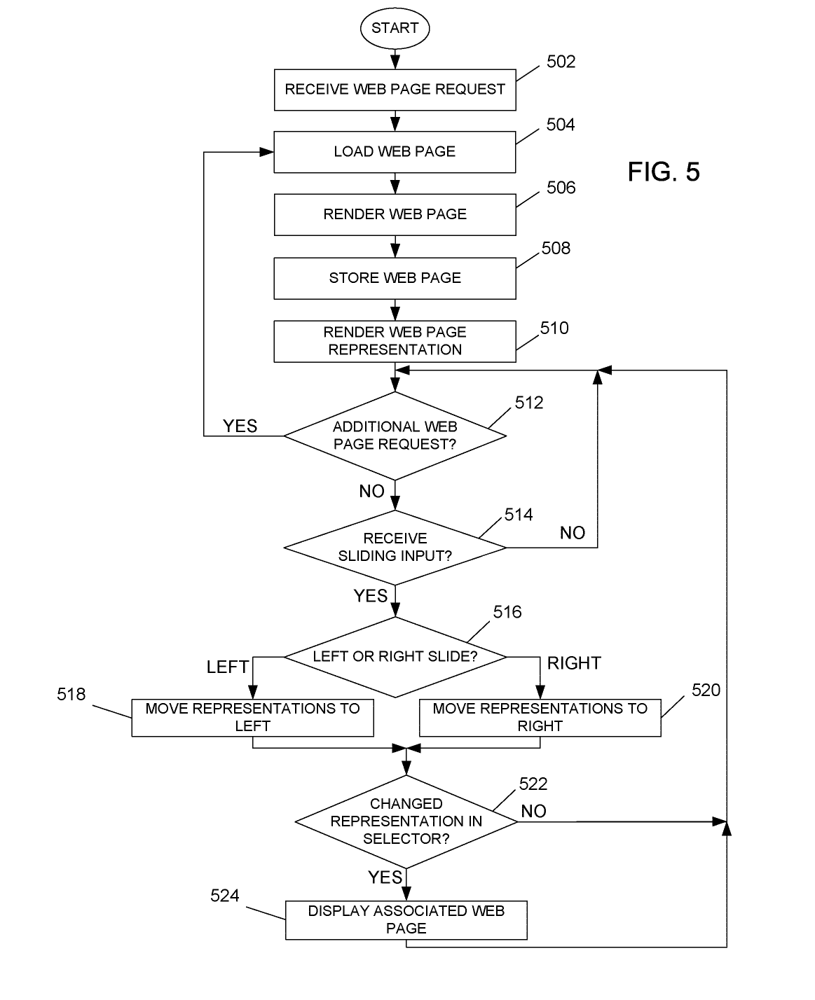

FIG. 5 is a flowchart illustrating an example of a portable electronic device method according to the present disclosure. Coding of software for carrying out such a method is within the scope of a person of ordinary skill in the art given the present description. Generally, a first web page is loaded 504 and rendered 506 on the display 110 of the portable electronic device 100. The first web page is stored 508 in memory at the portable electronic device 100 and a first selectable representation of the first web page is rendered 510 in a field on the display 110. The field includes at least one other selectable representation of another web page stored in memory.

The present method may be carried out utilizing the processor 102, executing a web browsing application stored in memory at the portable electronic device 100. Referring to FIG. 5, a web page request is received 502. The web page request may be received in response to selection of an option to load a web page, for example, from an entered URL or from selection of the web page from a bookmark in the browser, or utilizing any other suitable method.

The web page is loaded 504 at the portable electronic device 100. To load the web page, the request is transmitted wirelessly to the host system 250, for example, routed through the MDS 274 and then to the HTTP server 275. The HTTP server 275 then retrieves the web page over the Internet, and returns it to the MDS 274, as described above. The web page may be compressed and encrypted in any suitable manner and is pushed to the portable electronic device 100 via the shared network infrastructure 224 and the wireless network 200. The web page is received at the portable electronic device 100 where it is decompressed and decrypted. The web page is rendered 506 on the display 110 by laying out and displaying the web page on a portion of the display 110. The webpage is stored 508 in memory, such as RAM 106, at the portable electronic device 100.

A graphical representation of the webpage is created and rendered 510 in a field on the display 110. The graphical representation may be, for example, a thumbnail view of the web page or portion of the web page, or may be some other graphical representation such as an icon associated with the web page. The field in which the graphical representation of the webpage is rendered is included in a band along an edge of the display 110. For example, the band may be included along a top or bottom edge of the display 110. The terms top and bottom are used herein with reference to the orientation of the display 110 of the portable electronic device 100 when in use. The term top edge refers to the edge of the display 110 that is closest to the top of the displayed information in the orientation of the displayed information. The term bottom edge refers to the edge of the display 110 that is closest to the bottom of the displayed information in the orientation of the displayed information. The top and bottom edges may therefore change for example, in devices in which information may be displayed in different orientations based on the application or based on the orientation in which the portable electronic device 100 is held.

When other web pages are already loaded on the portable electronic device 100, the graphical representation of the web page is added to the other graphical representations of the web pages in the field in the band. When an additional web page request is received 512, the process continues at 504. Otherwise, a determination is made 514 whether or not sliding input is received. When sliding input is received, the direction of sliding input is determined 516. The sliding input may be, for example, scrolling utilizing the trackball 115 shown in the example of the portable electronic device 100 shown in FIG. 1. Scrolling from right to left causes the movement 518 of the graphical representations from right to left. Scrolling from left to right causes movement 520 of the graphical representations from left to right.

A selection box, located within the band, is maintained in the same location on the display 110 as the graphical representations are scrolled into or past the selection box. When the graphical representation in the selection box is changed 522, as the graphical representations are scrolled along the band, the associated web page is displayed 524 on the display 110. Thus, a web page may be selected for display by sliding the graphical representations until the one of the graphical representations associated with the desired web page is located in the selection box.

A limited number of graphical representations are displayed in the band at any one instance in time. For example, a total of four graphical representations may be displayed in the band at any one instance in time. More than four web pages may be loaded and stored in RAM 106, however, and therefore more than four graphical representations may be included in the field. Only four graphical representations are displayed and the remaining graphical representations, that are not displayed on the display 110, can be displayed by, for example, scrolling utilizing the trackball 115 to move the graphical representations within the band. Scrolling from right to left causes the graphical representations to appear to slide from right to left. The graphical representations may be animated to appear to slide to the left until they are off the display 110 and no longer displayed. Additional graphical representations enter the display 110 as the displayed graphical representations slide from right to left. Scrolling from left to right causes the graphical representations to appear to slide from left to right. The graphical representations may be animated to appear to slide to the right until they are off the display 110 and no longer displayed. Additional graphical representations enter the display 110 as the displayed graphical representations slide from left to right. The graphical representations may be wrapped such that the graphical representations may be scrolled in either direction to select any one web page; that is, continuous scrolling in one direction will loop through all of the graphical representations.

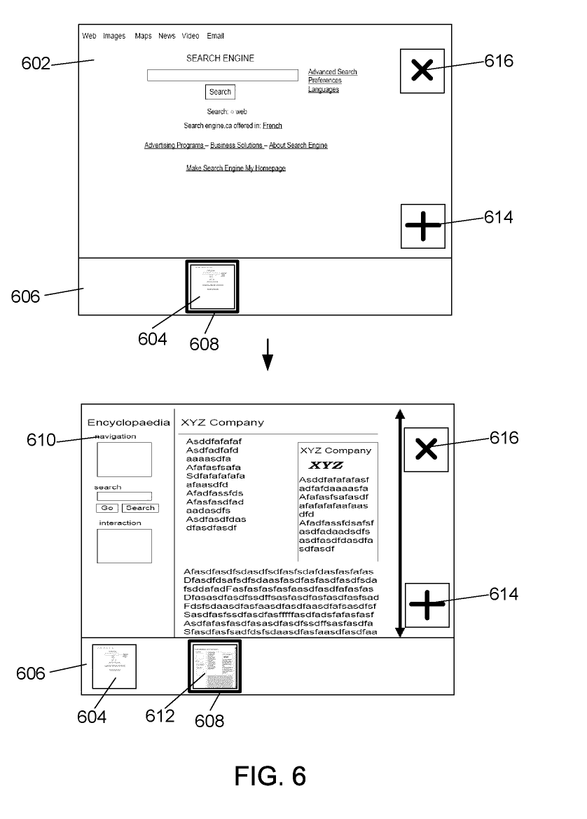

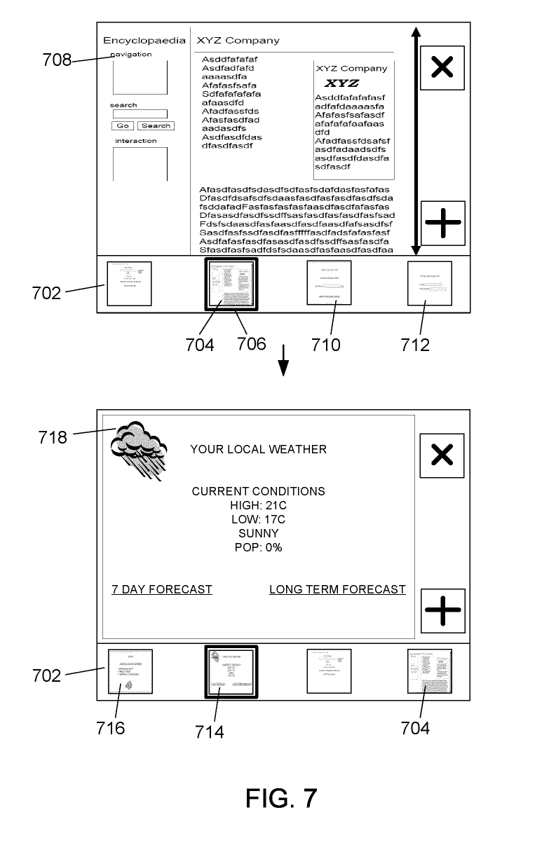

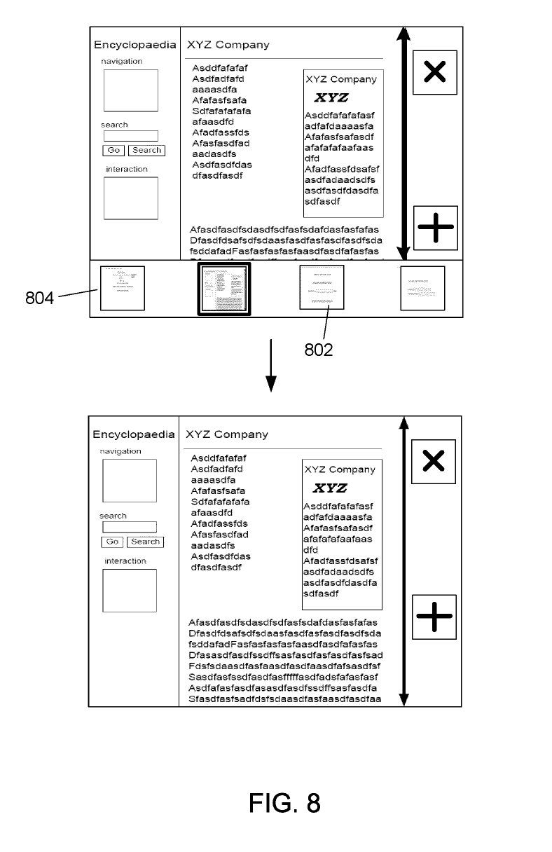

Specific examples of the method of FIG. 5 are illustrated in FIG. 6 and FIG. 7. In the examples of FIG. 6 and FIG. 7, web page requests are received in a web browsing application. In the upper illustration in FIG. 6, a web page request is received 502 and a search engine web page 602 is loaded 504 and rendered 506 on the display 110. The search engine web page 602 is also stored 508 in RAM 106 at the portable electronic device 100. A search engine web page representation 604 is rendered in a field in the band 606 which, in the present example, is located along the bottom edge of the display 110. The search engine web page 602 is the first web page stored in RAM in this example and therefore the associated search engine web page representation 604 is located within the selection box 608 in the band 606.

An additional web page request is received 512 and an encyclopedia web page 610 is loaded 604 and rendered 506 on the display 110. The encyclopedia web page 610 is also stored in RAM 106 at the portable electronic device 100. An encyclopedia web page representation 612 is rendered in the field in the band 606, in addition to the search engine web page representation 604. The encyclopedia web page representation 612 is displayed in the selection box 608 when the encyclopedia web page 610 is displayed.

Additional web page requests may be received and additional web pages loaded, rendered and stored at the portable electronic device. Associated web page representations are also rendered when additional web pages are loaded, rendered and stored. The additional web page requests may be received after user-selection of an option to load an additional web page, such as the button 614 shown on the right side of the display. An additional option to close any one of the web pages may also be provided. Selection of the option to close a web page, such as the button 616, closes the displayed web page, discontinuing display and the removal of the web page from memory. Additionally, the representation of the closed web page is removed from the field in the band 606.

Not all web pages visited are required to be opened and displayed in the manner described above. For example, an additional option can be provided to allow a currently displayed web page and the associated web page representation to be replaced by another web page and the respective web page representation.

In the illustrations of FIG. 7, multiple web pages are loaded, rendered and stored at the portable electronic device 100 and multiple associated web page representations are also rendered in the field in the band 702. An encyclopedia web page representation 704 is located in the selection box 706 in the band 702. Accordingly, the associated encyclopedia web page 708 is displayed on the display 110 in the upper illustration of FIG. 7.

Sliding input is received 514, for example, as the trackball 115 is scrolled from left to right. Scrolling from left to right 516 causes the graphical representations to be moved 520 from left to right. The graphical representations are animated to appear to slide to the right such that the two graphical representations 710, 712 on the right side of the display 110 slide off the display 110 and are therefore no longer displayed in the lower illustration of FIG. 7. Two additional graphical representations 714, 716 enter the display 110 as the displayed graphical representations slide from left to right. The encyclopedia web page representation 704 is moved to the right as the graphical representation 714 is moved into the selection box 706. Therefore, the graphical representation in the selection box is changed 522 to the graphical representation 714 and the associated web page 718 is displayed 524 on the display 110.

Although not shown in FIG. 5, display of the band that includes the field in which the web page representations are rendered may be discontinued after a threshold period of time passes without receiving input. For example, a timer may be started after the web page representation is rendered. The timer may be restarted when input is received or when another web page representation is rendered. When input is not received, the timer time may be compared to a threshold and, when the timer time exceeds the threshold, the band is no longer displayed. The band may be displayed again upon receipt of an input, such as a key press, trackball press, touch-screen tap, menu item selection, or using an icon (not shown) located at, for example, the bottom edge of the display 110. Displaying and hiding the band can be animated so that the band appears to slide on or off the display 110.

FIG. 8 illustrates one example of web page representations 802 rendered in the band 804. When input is not received and the timer time exceeds the threshold, the band 804 is no longer displayed, as shown in the lower illustration of FIG. 8. The band 804 is animated such that the band appears to slide off the display 110.

Although the embodiments are described with reference to a portable electronic device 100 that includes a trackball 115 for scrolling, the present disclosure is not limited to such a portable electronic device 100. In other embodiments, portable electronic devices including touch-sensitive input devices, touch-sensitive displays, optical trackpads, thumbwheels, or joysticks may utilize the described methods.

Advantageously, multiple web pages may be loaded and stored in memory at the portable electronic device at any one time. Thus, where multiple web pages are utilized, a web page may be selected without exiting other web pages and reloading a desired web page. Therefore, a previously loaded web page may be displayed without reloading the web page on the portable electronic device. This reduces data transmission between the portable electronic device and the host system. Further, transmission time and delay between loading of web pages is reduced, saving device power and reducing battery consumption. Additionally, the web pages are represented in a band that extends along an edge of the display. The band facilitates navigation without requiring additional screens or windows, for example and without discontinuing display of a web page on the display 110. The number of screens rendered to display the information may be reduced, reducing device use time, and thereby further reducing power consumption while providing an improved user interface.

While the embodiments described herein are directed to particular implementations of the electronic device and method of controlling the electronic device, the above-described embodiments are intended to be examples. It will be understood that alterations, modifications and variations may be effected without departing from the scope of the present disclosure.

What is claimed is:

1. A portable electronic device-implemented method comprising:
loading a first web page;
rendering the first web page on a display of the portable electronic device;
storing the first web page in memory at the portable electronic device; and
rendering a first selectable representation of the first web page in a field on the display, the field including at least one other selectable representation of another web page stored in memory.

2. The method according to claim 1, wherein rendering the first selectable representation comprises rendering the first selectable representation in the field, the field including other selectable representations of other web pages.

3. The method according to claim 2, comprising discontinuing displaying the first web page and displaying one of the other web pages in response to selection of an associated one of the selectable representations of the other web pages.

4. The method according to claim 1, comprising:
loading a second web page;
storing the second web page in memory at the portable electronic device;
rendering the second web page on a display of the portable electronic device; and
rendering a second selectable representation of the second web page in the field, along with the first selectable representation.

5. The method according to claim 4, comprising loading additional web pages, for each of the additional web pages loaded, storing, rendering, and rendering an associated selectable representation in the field, to provide a field with multiple selectable representations of web pages stored on the portable electronic device.

6. The method according to claim 5, wherein rendering the multiple selectable representations are rendered in the field in a band along the display.

7. The method according to claim 6, wherein a limited number of multiple selectable representations are displayed in the band and at one instance in time.

8. The method according to claim 7, wherein a first subset of the multiple selectable representations are displayed in the band and a further subset of the multiple selectable representations are displayed in response to receipt of an input to display a further subset of the selectable representations.

9. The method according to claim 8, wherein the subset of the multiple selectable representations are exchanged for the further subset of the multiple selectable representations displayed in the band in response to receipt of the input.

10. The method according to claim 9, wherein the subset of the multiple selectable representations and further subset of multiple selectable representations appear to slide along the band as the subset of the multiple selectable representations is exchanged for the further subset of the multiple selectable representations.

11. The method according to claim 10, wherein one of the multiple selectable representations is selected by sliding the multiple selectable representations until the one of the multiple selectable representations is located within a selection box in the field.

12. The method according to claim 11, comprising displaying the one of the web pages corresponding to the one of the multiple selectable representations when the one of the multiple selectable representations is located within the selection box in the field.

13. The method according to claim 1, comprising discontinuing displaying the field after a threshold period of time has passed absent navigation within the field.

14. A computer-readable medium having computer-readable code executable by at least one processor of a portable electronic device to perform the method of claim 1.

15. A portable electronic device comprising:
a display;
an input device;
a memory; and
a processor operably connected to the display, the input device and the memory to execute a program stored in the memory to cause the portable electronic device to load a first web page, render the first web page on the display, store the first web page in the memory, and render a first selectable representation of the first web page in a field on the display, the field including at least one other selectable representation of another web page stored in memory.
